(19) United States
(12) Patent Application Publication
(10) Pub. No.: US 2013/0034836 A1
(43) Pub. Date: Feb. 7, 2013

(54) Systems, Devices, and/or Methods for Handheld Devices

(71) Applicant: Stefanie Marshall, Charlottesville, VA (US)

(72) Inventor: Stefanie Marshall, Charlottesville, VA (US)

(21) Appl. No.: 13/195,079

(22) Filed: Aug. 1, 2011

(51) Int. Cl. G09B 19/00; B23P 11/00

(52) U.S. Cl. 434/236; 29/428

(57) ABSTRACT

Certain exemplary embodiments provide a cover adapted to partially enclose a handheld device. The cover can comprise a thermochromic material, which can be embedded in the cover. The thermochromic material can be adapted to change color and/or appearance responsive to a temperature change. In certain exemplary embodiments, the thermochromic material can be adapted to transfer heat from the handheld device to an environment surrounding the handheld device.

### CROSS-REFERENCES TO RELATED APPLICATIONS

This application claims priority to, and incorporates by reference herein in its entirety, pending U.S. Provisional Patent Application Ser. No. 60/374,660 (Attorney Docket No. 1014-001), filed 18 Aug. 2010.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a sketch of a plan view of an exemplary embodiment of a system 1000;

FIG. 2 is a sketch of a plan view of an exemplary embodiment of a system 2000 and a set of alternative embodiments of thermochromic images usable in system 2000;

FIG. 3 is a flowchart of an exemplary embodiment of a method 3000; and

FIG. 4 is a sketch of a plan view of an exemplary embodiment of a system 4000.

### DETAILED DESCRIPTION

Certain exemplary embodiments provide a cover adapted to partially enclose a handheld device. The handheld device can be a personal data assistant, cellular telephone, electronic music player, and/or electronic books reading system, etc. The cover can comprise a thermochromic portion fabricated from a thermochromic material, which can be embedded in the cover. The thermochromic material can be adapted to change color and/or appearance responsive to a temperature change such as responsive to heat energy received from a body part of a user of the handheld device. The thermochromic portion can be adapted to shield the handheld device from damage from an object impacting the handheld device. In certain exemplary embodiments, the thermochromic portion can be adapted to transfer heat generated by electronic circuitry of the handheld device to an environment substantially surrounding the handheld device.

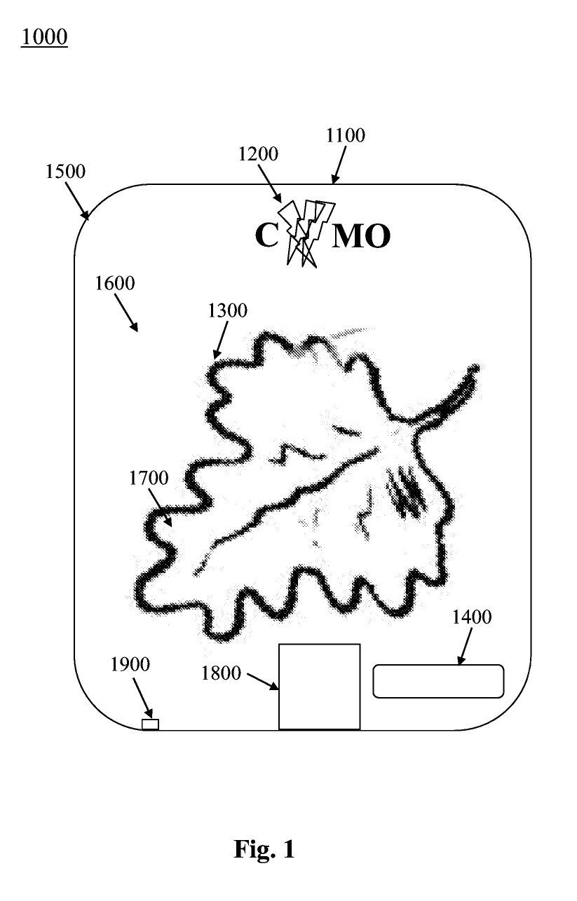

FIG. 1 is a sketch of a plan view of an exemplary embodiment of a system 1000, which illustrates an exemplary cover 1100 adapted to partially enclose a handheld device 1500. The illustrated cover 1100 has a representation of thermochromic portion 1300 in the shape of a leaf. In other embodiments, thermochromic portion 1300 can be any other shape, such as a shape resembling an animal, a plant, a word, object, letters, random shapes, symbols, and/or combinations thereof, etc. Cover 1100 can comprise a thermochromic crystal material placed onto and/or embedded into a backing material 1600, which can be flexible. An encapsulant 1700 can be placed over, and/or substantially surround, the thermochromic crystal material. Thermochromic portion 1300 of cover 1100 can change color and/or shape responsive to heat energy received from a body part of a user of handheld device 1500. System 1000 can comprise a logo 1200, which can comprise a thermochromic portion such as the illustrated renderings of lightning bolts. System 1000 can comprise a portion 1400, which in certain exemplary embodiments can be a location on which a logo such as logo 1200 is placed. In other embodiments, portion 1400 can define an opening in cover 1100 adapted for accessing an electronic control and/or button of handheld device 1500. Thermochromic portion 1300 can be adapted to shield handheld device 1500 from damage from an object impacting handheld device 1500.

Certain exemplary embodiments can comprise thermochromic liquid crystals placed into a hollow glass shell. The glass shell can be coupled to backing material 1600, which can comprise an elastomer, plastic, and/or metal, etc. The thermochromic liquid crystals react to subtle changes in the hand held device user's physical temperature, such as might occur due to changes of emotional state (subtle changes in cover temperature). The thermochromic liquid crystals can be sensitive to changes in temperature. A change in temperature can cause the thermochromic liquid crystals molecules to twist or change position. The resultant change in orientation can cause a change in the color and/or physical appearance of thermochromic portion 1300. The change in molecular structure can change the reflective and/or refractive properties of thermochromic portion 1300 to wavelengths of light, which can result in an apparent change in color. Thermochromic portion 1300 can be formulated such that a mid range of a color change is approximately 82 Degrees Fahrenheit, which can be an approximate skin temperature of a person using handheld device 1500.

Certain thermochromic materials are characterized by an activation temperature and a bandwidth. For example, an R40C5W can describe a thermochromic material that activates with a red color at approximately 40 degrees Celsius and the 5 W can indicate a blue color at approximately 5 degrees Celsius above the red color. Narrow band crystals can be defined for formulations that have a bandwidth that is less than approximately 2 degrees Celsius. Thermochromic materials can be encapsulated in a 5-10 micron sphere and/or suspended in a water based binder material. Encapsulation can shield thermochromic portion 1300. Alternately, thermochromic portion 1300 can be unencapsulated, which can provide relatively bright colors, but can be more susceptible to damage.

In certain exemplary embodiments, thermochromic portion 1300 can have one or more of the following color characteristics:
an observed black color can be indicative of an emotional state of stressed, tense, and/or feeling harried;
an observed gray color can be indicative of an emotional state of being nervous and/or anxious;
an observed amber/yellow color can be indicative of an emotional state of being nervous and/or anxious;
an observed green color can be indicative of an emotional state of being relaxed and/or normal;
an observed blue-green color can be indicative of an emotional state of being somewhat relaxed;
an observed blue color can be indicative of an emotional state of being somewhat calm and/or relaxed; and/or
an observed dark blue/navy color can be indicative of an emotional state of being happy, romantic, and/or passionate; etc.

Certain exemplary embodiments can comprise one or more tags, such as “displays your feelings”, “colors your feelings”, “for people who connect”, “when people connect with emotion”, “reconnect with your emotions”, “C-your feelings change”, and/or “mood rings”.

Certain exemplary embodiments comprise backing material 1600, which can be a sheet or roll of raw material. Backing material 1600 can comprise a base material, which can be metallic (e.g., aluminum foil), paper, fabric, plastic, synthetic resin, elastomer, and/or woven fiber, etc. Backing material 1600 can comprise or have an adhesive added thereto, which can be adapted to couple backing material 1600 to thermochromic portion 1300. Thermochromic portion 1300 can comprise a liquid crystal polymer and/or a liquid crystal encapsulant. The liquid crystal polymer can be applied via dispensing, depositing, screening, and/or spraying, etc. The liquid crystal polymer can be applied and/or heated for curing. The liquid crystal polymer can comprise thermochromic liquid crystals and/or cholesteric liquid crystal compositions, etc. The liquid crystal encapsulant can be applied over the liquid crystal polymer. The material applied can be cured. Artwork can be applied to improve the aesthetics of certain exemplary embodiments. Certain exemplary embodiments can be shaped by any method such as via singulation, a steel rule die, computer controlled cutting, and/or laser singulation, etc.

Thermochromic components can have a specific range of temperature or a temperature between approximately 35 and 36 degrees Celsius, approximately 36 and 37 degrees Celsius, approximately 37 and 38 degrees Celsius, and/or approximately 35 and 42 degrees Celsius, etc. In certain exemplary embodiments, a black or dark backing can directly underlie thermochromic components such that the thermochromic components appear black in certain conditions.

Because of the nature of liquid crystal compositions used, temperature responsive sections can produce various colors depending upon temperature. For example, when certain exemplary components are heated first to approximately 35 degrees Celsius and the temperature is gradually elevated to approximately 36 degrees Celsius, those components will first be colored red and the color can change successively from red to orange, yellow, green, light blue, dark blue and purple.

Certain exemplary embodiments provide thermochromic elastic articles, which can comprise an elastic polymeric composition having at least one elastomeric polymer. The elastomeric polymer or polymers can be selected from any suitable elastomeric emulsion-based polymers and elastomeric solution-based polymers. Emulsion-based polymers can comprise polymers dispersed in liquids such as aqueous or other liquids. For example, thermochromic elastic articles can comprise one or more of a natural rubber latex, a synthetic latex-like polymer such as a nitrile rubber (e.g., a nitrile butadiene rubber), polyurethane, styrene butadiene, neoprene, isoprene, styrene-ethylene-butylene-styrene (S-EB-S), styrene-isoprene-styrene (S-I-S), styrene-polybutydiene-styrene (S-B-S), and/or polyvinyl chloride (PVC) polymers, etc. Certain exemplary embodiments can comprise elastomeric polymers, which can be made from suitable solutions or emulsions.

Leuco dyes and cholesteric liquid crystals are two examples of thermochromic pigments or ingredients that can be used in certain exemplary embodiments as thermochromic materials. Any suitable thermochromic pigment or ingredient may be used.

Certain exemplary embodiments can comprise a belt clip for handheld device 1500 such that handheld device 1500 can be worn on a belt. Also, cover 1100 itself (without any additional parts) can be wrapped over a belt, so that it can be worn by a user on his belt. Also, cover 1100 can be attached to the belt, pants, skirt, shirt, or purse, with a string, tether, band, belt, or chain, through cover 1100, on cover 1100, in-between cover 1100 (e.g. a pocket), or inside cover 1100.

In certain exemplary embodiments, buttons of handheld device 1500 can be partially and/or substantially enclosed by cover 1100. In one embodiment, cover 1100 comprises a flap 1800, which can be pulled back, to let the user access different parts of handheld device 1500. Flap 1800 can be placed at any suitable location in cover 1100. In certain exemplary embodiments, cover 1100 can comprise a plurality of flaps.

In certain exemplary embodiments, cover 1100 can comprise: plastic, elastic material, nylon, bubble-protection material, layered material, soft material, synthetic material, shock absorbent material, hard material, solid material, liquid-containing material, gas-containing material, pressurized-gas-containing material, balloon-type material, inflatable material, gel-type material, natural material, leather, water-proof material, oil-protected surface, paper, cardboard, stretchable material, elastic band network, net-shape material, magnetic material, metallic material, metallic chain, array of metallic rings, multi-dimensional structure, folded structure, hinges, hinged plates, hinged micro-plates, connected tiles, Lego-shaped material, brick-shaped material, ceramic tiles, stone tiles, artificial material tiles, glass tiles, transparent material, translucent material, reflective material, fluorescent material, metal-plated material, painted material, rug, woven material, bamboo, carpet material, wooden material, sticks, insulation material, water-cooling jacket, air-cooling jacket, heating-element jacket, insulation jacket, or any similar, compound, chemical, and/or composite material, etc.

In certain exemplary embodiments, cover 1100 can comprise and/or be operatively coupled to a picture frame, clock, notebook, calculator, solar cell array, battery, pen holder, pen, pencil, magnetic plate, magnetic decoration, light, LED, LCD, display, small TV, small radio, thermometer, pressure gauge, biometric sensor, thumb/fingerprint recognition module, combination lock, lock, Velcro, hook-and-loop, password entry input, small keyboard, input device, pointing device, speaker, microphone, small telephone set, keychain ring, hook (for hanging the unit), small video game, music player, downloading unit (from Internet or satellite), wireless unit, communication unit, antenna (e.g., bi-directional signal amplifier antenna), small computer, small web browser, recorder, or any other electronic or mechanical device, apparatus, system, toy, decoration, and/or equipment, etc.

In certain exemplary embodiments, the size or shape of cover 1100 can be adjustable based on the size, model, or type of handheld device 1500 device. For example, cover 1100 can be adjusted via inflation based on the size, model, or type of handheld device 1500. Cover 1100 can be adapted to automatically adjust in size to fit handheld device 1500 based upon feedback from a sensor 1900. The size or shape of cover 1100 can be adjusted by one or more of the following, or a combination of the following: a user, a computer, feedback from one or more sensors, feedback module, pressure gauges at different points, data about the model number or type of handheld device 1500, data about the dimensions or weight of handheld device 1500, fuzzy logic system, a training module, or a neural network module. Cover 1100 can comprise multiple parts or chambers each of which can be optimized, inflated separately, and/or or in inflated concert with respect to each other.

Cover 1100 can comprise a gel elastomer having polymer material (e.g., styrene, ethylene, butylene, and/or styrene block copolymer, etc.), which can be mixed with a paraffin-based mineral oil to form a gel. Cover 1100 can comprise edges of metallic foil and/or a polymeric laminate. Cover 1100 can comprise:
a crystallite covering adapted to isolate electromagnetic waves of handheld device 1500 from contacting the user;
a flexible fabric belt adapted to cover front and back sides of handheld device 1500, the flexible fabric belt can comprise a plurality of crystallites fixedly provided at a front sidewall thereof and arranged to show different designs and adapted to isolate electromagnetic waves of handheld device 1500; and/or
a plurality of transverse strips of loop material fixedly provided at a back sidewall thereof and fastened to respective transverse strips of hook material of handheld device 1500.

Certain exemplary embodiments provide cover 1100 adapted to substantially enclose handheld device 1500 device, which can be substantially rectilinearly-shaped and can comprise an external antenna. Cover 1100 can comprise a web portion adapted to substantially shield opposing sides and/or top and bottom portions of handheld device 1500. An opening can be arranged through at least one of the enclosure web portions to permit exposure of certain components of handheld device 1500, and a corner pad can be arranged on corner portions of handheld device 1500 to cushion from an impact if handheld device 1500 is dropped.

Cover 1100 can be adapted for substantially enclosing and/or protecting handheld device 1500 substantially without interfering with the normal functionality of handheld device 1500. Cover 1100 can comprise walls, which define an interior volume for substantially enclosing handheld device 1500 in a substantially waterproof protective covering. Cover 1100 can comprise speaker wells and/or microphone wells which can allow relatively uninhibited communication with the telephone through cover 1100 and can be selectively filled with a speaker plug and/or microphone plug when the telephone is not in use to maintain waterproofing of cover 1100. A transparent window can be provided to allow buttons of the telephone to be operated and displays to be visualized. A top and/or side opening of cover 1100 can allow handheld device 1500 to be inserted into cover 1100. An overhead strap and/or side straps can be used to close cover 1100 to maintain waterproofing of cover 1100.

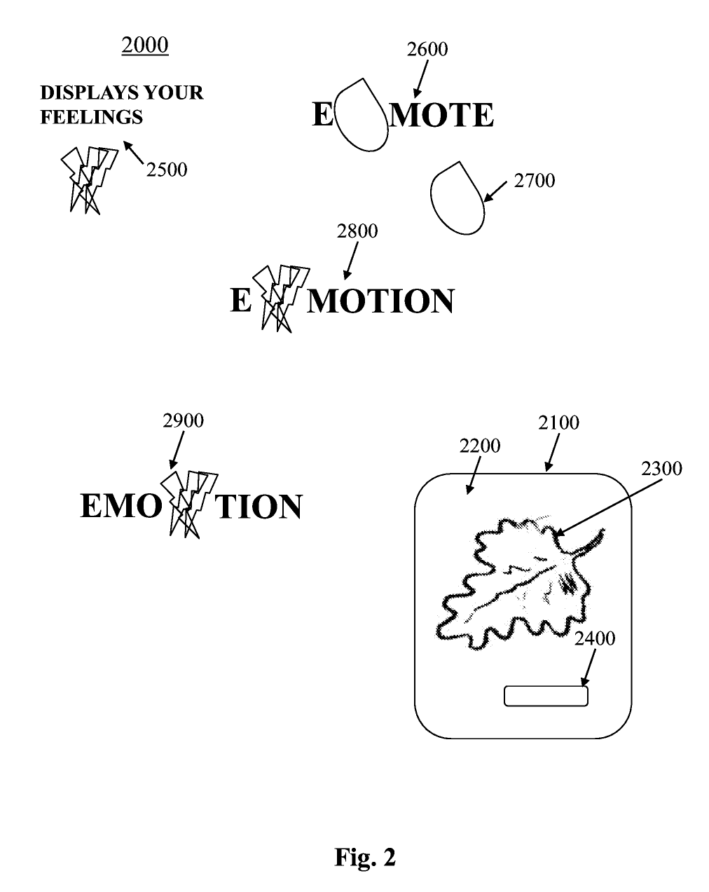

FIG. 2 is a sketch of a plan view of an exemplary embodiment of a system 2000 and a set of alternative embodiments of thermochromic images usable in system 2000. For example, thermochromic images can comprise one or more of first thermochromic image 2500, second thermochromic image 2600, third thermochromic image 2700, fourth thermochromic image 2800, and/or fifth thermochromic image 2900. Certain exemplary embodiments provide a cover 2200 adapted for use with a handheld device 2100. In certain exemplary embodiments, a thermochromic portion 2300 of cover 2200 can be adapted to transfer heat from handheld device 2100 to a surrounding environment. Thermochromic portion 2300 can receive heat energy from electronic circuitry of handheld device 2100. The heat can then be transferred via conduction from an interior portion of cover 2200 to a surface of cover 2200 exposed to the environment. The heat energy can be transferred via conduction or convection from cover 2200 to the environment. System 2000 can comprise a portion 2400, which in certain exemplary embodiments can be a location for a logo such one or more of first thermochromic image 2500, second thermochromic image 2600, third thermochromic image 2700, fourth thermochromic image 2800, and/or fifth thermochromic image 2900. In other embodiments, portion 2400 can define an opening in cover 2200 adapted for accessing an electronic control and/or button of handheld device 2100.

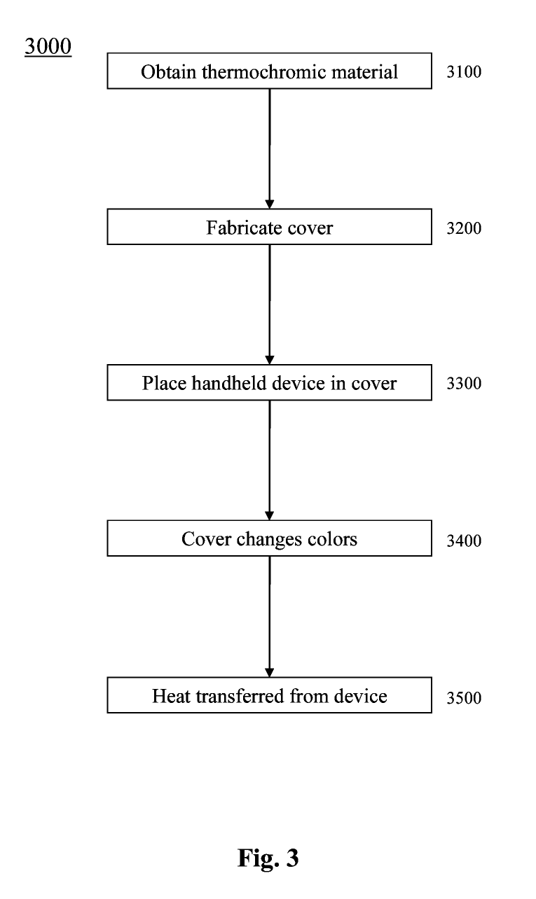

FIG. 3 is a flowchart of an exemplary embodiment of a method 3000. At activity 3100, thermochromic material can be obtained. At activity 3200, a cover can be fabricated utilizing the thermochromic material. The thermochromic portion can be adapted to change color responsive to heat energy received from a body part of a user of the handheld device. The thermochromic material and/or the cover can be adapted to transfer heat generated by electronic circuitry of a handheld device to an environment in proximity to and/or substantially surrounding the handheld device.

At activity 3300, a handheld device can be placed in the cover. The cover can be adapted to shield the handheld device from damage due to dropping the handheld device and/or having an object come into contact with the handheld device. At activity 3400, one or more colors of the thermochromic material can change responsive to a temperature of a user in contact with the cover.

At activity 3500, heat generated by the handheld device can be transferred to the environment such as via convective and/or conductive heat transfer. In certain exemplary embodiments, electronic circuitry of the handheld device can generate heat, which is then transferred via the cover to the surrounding environment.

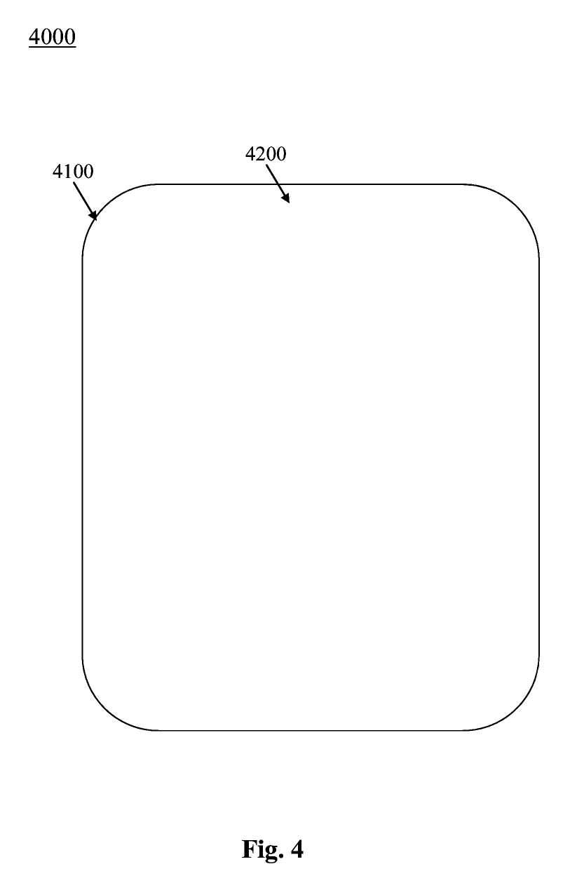

FIG. 4 is a sketch of a plan view of an exemplary embodiment of a system 4000, which can comprise a handheld device 4100 and a cover 4200. Cover 4200 can have a thermochromic portion that comprises a thermochromic material. In certain exemplary embodiments, the thermochromic material can be substantially throughout cover 4200. In such embodiments, cover 4200 can display colors responsive to a touch of a user. For example, cover 4200 can be adapted to substantially display images of fingers of the user as the user touches cover 4200. The color of the images can be related to a body temperature of the user and can be reflective of an emotional state of the user.

In certain exemplary embodiments, cover 4200 can be elastically deformable and can be stretched to install cover 4200 on handheld device 4100. In such embodiments, one or more edges of cover 4200 can restrain motion of cover 4200 relative to handheld device 4100 to resist cover 4200 becoming separated from handheld device 4100.

### DEFINITIONS

When the following terms are used substantively herein, the accompanying definitions apply. These terms and definitions are presented consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
adapter—a device used to effect operative compatibility between different parts of one or more pieces of an apparatus or system.
adjust—to alter and/or move something in order to achieve the desired fit, appearance, and/or result.
and/or—either in conjunction with or in alternative to.
apparatus—an appliance or device for a particular purpose.
associate—to join, connect together, and/or relate.
automatic—acting or operating in a manner essentially independent of external influence or control. For example, an automatic light switch can turn on upon “seeing” a person in its view, without the person manually operating the light switch.
backing—layer of material that forms, protects, or strengthens the back of something.
body part—any part of a human such as an organ or extremity.
can—is capable of, in at least some embodiments.
cause—to make something happen.
change—to make the form, nature, content, and/or future course, etc., of something different from what it is or from what it would be if left alone.
comprising—including but not limited to.
configure—to make suitable or fit for a specific use or situation.
connect—to join or fasten together.
coupleable—capable of being joined, connected, and/or linked together.
coupling—linking in some fashion.
cover—a thing that lies on, over, and/or around something, especially in order to protect or shield it.
crystal—a piece of a substantially homogeneous solid substance having a substantially geometrically regular form with substantially symmetrically arranged plane faces.
damage—to cause a physical change in something so as to impair its value, usefulness, and/or normal function.
define—to establish the outline, form, or structure of.
determine—to obtain, calculate, decide, deduce, and/or ascertain.
device—a machine, manufacture, and/or collection thereof.
elastomeric polymer—a large molecule composed of repeating structural units with the property of viscoelasticity, generally having relatively low Young's modulus and relatively high yield strength.
electronic circuitry—an electrical network is an interconnection of electrical elements such as resistors, inductors, capacitors, transmission lines, voltage sources, current sources, and switches.
encapsulant—a material adapted to coat another substance.
enclose—substantially surround.
environment—surroundings or conditions in which thing exists.
fabricate—to construct or manufacture.
flap—a piece that is hinged or attached only on one side, that covers an opening or hangs down from something.
handheld—adapted to be carried around in a person's hand and adapted for mobile use.
heat energy—a form of energy that is transferred by a difference in temperature.
impact—to come into forcible contact with an object.
install—to connect or set in position and prepare for use.
may—is allowed and/or permitted to, in at least some embodiments.
method—a process, procedure, and/or collection of related activities for accomplishing something.
object—a material thing that can be seen and touched.
obtain—to get, acquire, procure and/or secure something.
partially—in part.
place—to put in a particular position.
portion—a part of a whole.
plurality—the state of being plural and/or more than one.
predetermined—established in advance.
set—a related plurality.
shield—to prevent or reduce a danger and/or risk.
substantially—to a great extent or degree.
support—to bear the weight of, especially from below.
surround—to substantially encompass something.
system—a collection of mechanisms, devices, machines, articles of manufacture, processes, data, and/or instructions, the collection designed to perform one or more specific functions.
thermochromic—a substance adapted to change color due to a change in temperature.
transfer—to move something from one place to another.
user—a person that operates something.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a cover adapted to partially enclose a handheld device, said cover comprising a thermochromic portion, said thermochromic portion adapted to change color responsive to heat energy received from a body part of a user of said handheld device, said thermochromic portion adapted to transfer heat generated by electronic circuitry of said handheld device to an environment substantially surrounding said cover.

2. The system of claim 1, further comprising:
said handheld device.

3. The system of claim 1, wherein:
said thermochromic portion is adapted to shield said handheld device from damage from an object impacting said handheld device.

4. The system of claim 1, wherein:
said thermochromic portion comprises thermochromic crystal material.

5. The system of claim 1, wherein:
said thermochromic portion comprises a thermochromic crystal material substantially surrounded by an encapsulant.

6. The system of claim 1, wherein:
said cover comprises a backing material and an adhesive adapted to couple said backing material to said thermochromic portion.

7. The system of claim 1, wherein:
said cover comprises an elastomeric polymer.

8. The system of claim 1, wherein:
said cover comprises a flap.

9. The system of claim 1, wherein:
said cover is adjustable in size to fit different sizes of handheld devices.

10. The system of claim 1, wherein:
said cover is adapted to automatically adjust in size to fit said handheld device based upon feedback from a sensor.

11. The system of claim 1, wherein:
said cover is adapted to automatically adjust in size to fit said handheld device, via a neural network module, based upon feedback from a sensor.

12. The system of claim 1, wherein:
said cover is adapted to automatically adjust in size to fit said handheld device, via a fuzzy logic system, based upon feedback from a sensor.

13. The system of claim 1, wherein:
said cover is adapted to automatically adjust in size to fit said handheld device, via a training module, based upon feedback from a sensor.

14. The system of claim 1, wherein:
said cover is adapted to automatically adjust in size, via inflation, to fit said handheld device based upon feedback from a sensor.

15. A method comprising a plurality of activities, comprising:
fabricating a cover on a handheld device, said cover comprising a thermochromic portion, said thermochromic portion adapted to change color responsive to heat energy received from a body part of a user of said handheld device, said thermochromic portion adapted to transfer heat generated by said handheld device to an environment substantially surrounding said cover.

16. The method of claim 15, further comprising:
causing said handheld device to be placed in said cover.

17. The method of claim 15, further comprising:
obtaining thermochromic material comprised by said thermochromic portion.

18. The method of claim 15, further comprising:
causing heat generated by electronic circuitry of said handheld device to be transferred from said thermochromic portion to said environment.

19. The method of claim 15, further comprising:
causing said thermochromic portion to change color.
